(19) United States
(12) Patent Application Publication
(10) Pub. No.: US 2023/0351449 A1
(43) Pub. Date: Nov. 2, 2023

(54) SYSTEMS AND METHODS FOR SCHEDULING AUTOMATED INFORMATION DELIVERY TO A USER DEVICE

(71) Applicant: Juan Pablo Torre, Manhattan Beach, CA (US)

(72) Inventor: Juan Pablo Torre, Manhattan Beach, CA (US)

(21) Appl. No.: 18/309,746

(22) Filed: Apr. 28, 2023

Related U.S. Application Data
(60) Provisional application No. 63/336,194, filed on Apr. 28, 2022.
(60) Provisional application No. 63/336,190, filed on Apr. 28, 2022.
(60) Provisional application No. 63/498,819, filed on Apr. 28, 2023.

(51) Int. Cl. G06Q 30/0272; G06Q 30/0204; G06Q 50/12; G06Q 30/0241; G06Q 30/0251

(52) U.S. Cl. CPC G06Q 30/0272; G06Q 30/0205; G06Q 50/12; G06Q 30/0276; G06Q 30/0256; G06Q 30/0269; G06Q 30/0249; G06Q 30/0277

(57) ABSTRACT

Provided are methods and apparatus for scheduling automated information delivery to a user device. In examples, provided are computer-implemented methods for scheduling automated information delivery to a user device. At least a portion of the methods can be performed by a computing device including a processor. The methods can include (i) receiving, automatically via an application programming interface executed by the processor, information describing characteristics of potential hotel guests, characteristics of a hotel, and user input describing characteristics of an advertising campaign, (ii) creating, using a machine learning algorithm, advertising campaign information including instructions configured to direct an Internet search website to automatically display advertisements for the hotel that accompany search results, and (iii) sending the instructions to a server device configured automatically cause the advertisements for the hotel to be displayed on the user device. Various other methods, systems, and computer-readable media are also disclosed.

### CROSS-REFERENCE TO RELATED APPLICATIONS

This application claims the benefits of U.S. Provisional Patent Application No. 63/336,194, titled “SYSTEMS AND METHODS FOR SCHEDULING AUTOMATED INFORMATION DELIVERY”, filed Apr. 28, 2022; U.S. Provisional Patent Application No. 63/336,190, titled “SYSTEMS AND METHODS FOR AUTOMATED INFORMATION DELIVERY TO A MOBILE DEVICE BASED ON GEOLOCATION OF THE MOBILE DEVICE”, filed Apr. 28, 2022; and U.S. Provisional Patent Application No. 63/498,819, titled “SYSTEMS AND METHODS FOR SCHEDULING AUTOMATED INFORMATION DELIVERY”, filed Apr. 28, 2023; the disclosures of which are incorporated herein by reference in their entireties.

### FIELD OF DISCLOSURE

This disclosure relates to the technical field of electronics, and more specifically, but not exclusively, to methods and apparatus that schedule automated information delivery to a user device.

### BACKGROUND

As the number of hotels has increased, there is great competition to attract hotel guests via online advertising. Online advertising can be expensive and may not sufficiently target potential hotel guests. Attracting hotel guests to a specific hotel via third-party booking platforms can be expensive and may not provide sufficient value to a hotelier because the third-party booking platforms promote large numbers of hotels, while underpromoting the specific hotel of the hotelier.

Accordingly, there are previously unaddressed and long-felt industry needs for methods and apparatus which improve upon conventional methods and apparatus.

### SUMMARY

In an example, a computer-implemented method for scheduling automated information delivery to a user device can include (i) receiving, automatically via an application programming interface executed by the at least one tangible processor, information describing at least one of demographics of potential hotel guests, a geographic location of the potential hotel guests, pricing for room rental in the hotel, a uniform resource locator of a hotel website describing amenities of the hotel and at least one image of the hotel, user input describing a characteristic of a target audience of the advertising campaign, or user input describing a budget for the advertising campaign; (ii) creating, using a machine learning algorithm processing the received information, advertising campaign information, where the information describing the advertising campaign can include at least one of instructions configured to direct an Internet search website to automatically display advertisements for the hotel that accompany search results displayed by the Internet search website, between an advertising campaign start date and an advertising campaign end date, and to the potential hotel guests in the geographic location of the potential hotel guests; the information describing the amenities of the hotel and the at least one image of the hotel; the information describing the pricing for room rental in the hotel; or information describing a competitive advertising budget; and (iii) sending the instructions configured to direct the Internet search website to automatically display the advertisements for the hotel to a server device configured to automatically cause the advertisements for the hotel to be displayed on the user device.

In some embodiments, the method can further include retrieving, using the uniform resource locator, the information describing the amenities of the hotel and the at least one image of the hotel.

In some examples, the method can further include receiving, from a user interface device, an instruction to initiate performing the creating the advertising campaign information step.

In some examples, the method can further include (i) receiving, via a user interface device, user profile information describing at least one of a username, a user email address, a user company, or the uniform resource locator of the hotel website; (ii) receiving, via the user interface device, information confirming the user profile information; (iii) storing, in response to the receiving the information confirming the user profile information, the user profile information in a tangible non-transient storage device; and (iv) enabling the creating the advertising campaign information in response to the receiving the information confirming the user profile information.

In some examples, the method can further include (i) receiving, via a user interface device, additional campaign information describing an advertising campaign name and an advertising campaign description; (ii) associating the received additional campaign information with the advertising campaign information; and (iii) storing, in a tangible non-transient storage device, the received additional campaign information with the advertising campaign information.

In some examples, the method can further include displaying, on a screen of the user device, information describing at least one of an advertising campaign name; the advertising campaign start date; the advertising campaign end date; the budget for the advertising campaign; an amount of funds spent to date on the advertising campaign; a total number of advertisements in the advertising campaign; a number of user inputs received to date as a result of the advertising campaign; or a campaign calendar identifying the advertising campaign start date, the advertising campaign end date, and all dates therebetween.

In some examples, the method can further include displaying, on a screen of the user device, information describing at least one of a campaign calendar identifying the advertising campaign is unpaid for; or a request for payment information.

In one embodiment, a system for scheduling automated information delivery to a user device can include at least one physical processor and a physical memory communicably coupled to the at least one physical processor and storing instructions configured to cause the at least one physical processor to (i) receive, automatically via an application programming interface executed by the at least one tangible processor, information describing at least one of demographics of potential hotel guests, a geographic location of the potential hotel guests, pricing for room rental in the hotel, a uniform resource locator of a hotel website describing amenities of the hotel and at least one image of the hotel, user input describing a characteristic of a target audience of the advertising campaign, or user input describing a budget for the advertising campaign; (ii) create, using a machine learning algorithm processing the received information, advertising campaign information, where the information describing the advertising campaign can include at least one of instructions configured to direct an Internet search website to automatically display advertisements for the hotel that accompany search results displayed by the Internet search website, between an advertising campaign start date and an advertising campaign end date, and to the potential hotel guests in the geographic location of the potential hotel guests; the information describing the amenities of the hotel and the at least one image of the hotel; the information describing the pricing for room rental in the hotel; or information describing a competitive advertising budget; and (iii) send the instructions configured to direct the Internet search website to automatically display the advertisements for the hotel to a server device configured to automatically cause the advertisements for the hotel to be displayed on the user device.

In some examples, the physical memory can further store instructions configured to cause the at least one physical processor to retrieve, using the uniform resource locator, the information describing the amenities of the hotel and the at least one image of the hotel.

In some examples, the physical memory can further store instructions configured to cause the at least one physical processor to receive, from a user interface device, an instruction to initiate performing the creating the advertising campaign information step.

In some examples, the physical memory can further store instructions configured to cause the at least one physical processor to (i) receive, via a user interface device, user profile information describing at least one of a username, a user email address, a user company, or the uniform resource locator of the hotel website; (ii) receive, via the user interface device, information confirming the user profile information; (iii) store, in response to the receiving the information confirming the user profile information, the user profile information in a tangible non-transient storage device; and (iv) enable the creating the advertising campaign information in response to the receiving the information confirming the user profile information.

In some examples, the physical memory can further store instructions configured to cause the at least one physical processor to (i) receive, via a user interface device, additional campaign information describing an advertising campaign name and an advertising campaign description; (ii) associate the received additional campaign information with the advertising campaign information; and (iii) store, in a tangible non-transient storage device, the received additional campaign information with the advertising campaign information.

In some examples, the physical memory can further store instructions configured to cause the at least one physical processor to display, on a screen of the user device, information describing at least one of an advertising campaign name; the advertising campaign start date; the advertising campaign end date; the budget for the advertising campaign; an amount of funds spent to date on the advertising campaign; a total number of advertisements in the advertising campaign; a number of user inputs received to date as a result of the advertising campaign; or a campaign calendar identifying the advertising campaign start date, the advertising campaign end date, and all dates therebetween.

In some examples, the physical memory can further store instructions configured to cause the at least one physical processor to display, on a screen of the user device, information describing at least one of a campaign calendar identifying the advertising campaign is unpaid for or a request for payment information.

In some examples, the methods described herein can be encoded as computer-readable instructions on a non-transitory computer-readable medium. For example, a computer-readable medium can include one or more computer-executable instructions that, when executed by at least one processor of a computing device, can cause the computing device to (i) receive, automatically via an application programming interface executed by the at least one tangible processor, information describing at least one of demographics of potential hotel guests, a geographic location of the potential hotel guests, pricing for room rental in the hotel, a uniform resource locator of a hotel website describing amenities of the hotel and at least one image of the hotel, user input describing a characteristic of a target audience of the advertising campaign, or user input describing a budget for the advertising campaign; (ii) create, using a machine learning algorithm processing the received information, advertising campaign information, where the information describing the advertising campaign can include at least one of instructions configured to direct an Internet search website to automatically display advertisements for the hotel that accompany search results displayed by the Internet search website, between an advertising campaign start date and an advertising campaign end date, and to the potential hotel guests in the geographic location of the potential hotel guests; the information describing the amenities of the hotel and the at least one image of the hotel; the information describing the pricing for room rental in the hotel; or information describing a competitive advertising budget; and (iii) send the instructions configured to direct the Internet search website to automatically display the advertisements for the hotel to a server device configured to automatically cause the advertisements for the hotel to be displayed on the user device.

In some examples, the computer-executable instructions can be further configured to cause the at least one processor of a computing device to retrieve, using the uniform resource locator, the information describing the amenities of the hotel and the at least one image of the hotel.

In some examples, the computer-executable instructions can be further configured to cause the at least one processor of a computing device to receive, from a user interface device, an instruction to initiate performing the creating the advertising campaign information step.

In some examples, the computer-executable instructions can be further configured to cause the at least one processor of a computing device to (i) receive, via a user interface device, user profile information describing at least one of a username, a user email address, a user company, or the uniform resource locator of the hotel website; (ii) receive, via the user interface device, information confirming the user profile information; (iii) store, in response to the receiving the information confirming the user profile information, the user profile information in a tangible non-transient storage device; and (iv) enable the creating the advertising campaign information in response to the receiving the information confirming the user profile information.

In some examples, the computer-executable instructions can be further configured to cause the at least one processor of a computing device to (i) receive, via a user interface device, additional campaign information describing an advertising campaign name and an advertising campaign description; (ii) associate the received additional campaign information with the advertising campaign information; and (iii) store, in a tangible non-transient storage device, the received additional campaign information with the advertising campaign information.

In some examples, the computer-executable instructions can be further configured to cause the at least one processor of a computing device to display, on a screen of the user device, information describing at least one of an advertising campaign name; the advertising campaign start date; the advertising campaign end date; the budget for the advertising campaign; an amount of funds spent to date on the advertising campaign; a total number of advertisements in the advertising campaign; a number of user inputs received to date as a result of the advertising campaign; or a campaign calendar identifying the advertising campaign start date, the advertising campaign end date, and all dates therebetween.

In some examples, the computer-executable instructions can be further configured to cause the at least one processor of a computing device to display, on a screen of the user device, information describing at least one of a campaign calendar identifying the advertising campaign is unpaid for or a request for payment information.

Features from any of the embodiments described herein can be used in combination with another embodiment in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings are presented to describe examples of the present teachings and are not limiting. Together with this following description, the drawings demonstrate and explain various principles of the present disclosure.

FIG. 1 depicts a block diagram of an example network architecture suitable for implementing examples of the disclosed subject matter.

FIG. 2 depicts a block diagram of an example computing device suitable for implementing examples of the disclosed subject matter.

FIG. 3 depicts an example method for scheduling automated information delivery to a user device.

FIG. 4 depicts an example process flow of an example method for scheduling automated information delivery to a user device.

FIG. 5 depicts an example user interface screen depicting a dashboard display of booking rates and advertising expenses.

FIG. 6 depicts an example user interface screen depicting a display of an advertising campaign manager.

FIG. 7 depicts an example user interface screen depicting a display of an advertising campaign scheduling calendar.

FIG. 8A depicts an example user interface screen configured to display and to receive user input information describing basic information about a new advertising campaign.

FIG. 8B depicts an example user interface screen configured to display and to receive user input information describing advertising campaign start and end dates of an advertising campaign.

FIG. 9 depicts an example user interface screen configured to display and receive information describing details about at least one advertising campaign.

FIG. 10 depicts an example user interface screen configured to display and receive information describing a user profile.

FIG. 11 depicts an example user interface screen for configured to display and receive information describing at least one advertising campaign.

FIG. 12A depicts an example user device display screen displaying, in conjunction with a map, an advertisement that is part of an advertising campaign.

FIG. 12B depicts an example user device display screen displaying, as part of sponsored advertising being displayed in conjunction with search results provided by a search engine, an advertisement that is part of an advertising campaign.

Each of the drawings is provided for illustration and description only and does not limit the present disclosure. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Provided are methods and apparatuses that schedule automated information delivery to a user device. In examples, the provided methods and apparatuses can provide user-friendly techniques that enable users to easily create advertising campaigns for a hotel that target specific potential guests who are looking for accommodations in a particular geographic region. The provided techniques can advantageously increase direct hotel reservation bookings, while reducing commission costs associated with advertising, relative to commission costs associated with online travel agencies. In examples, the provided techniques can enable a user to advertise to a wider audience and increase visibility of their hotel in search engine results. In some examples are provided techniques can enable a user to create and display advertising that targets at least one specific person, at least one specific group of people, or combination thereof, which can increase a return on investment in advertising costs. Further, in some examples a user can guide potential hotel guests directly to a hotel website to book a reservation, instead of relying upon an online travel agency to book the reservation, thus reducing commission costs associated with using the online travel agency as a booking agent.

In some examples, the provided methods and apparatuses can automatically analyze a hotel website to generate targeted advertising. The user can choose a target audience, set in advertising budget, and launch an advertising campaign with only a few user interface clicks. The provided methods and apparatuses can increase search engine optimization relevancy of hotel advertisements to improve advertising placement, thus improving competitiveness of the hotel.

Further, the provided methods and techniques can advantageously operate without installing cookies or other computer code on hotel website, on a potential hotel guest's user device, or both.

Accordingly, provided are systems and methods that can perform functions such as using a machine-learning algorithm to create an advertising campaign. In some examples, a computer server can implement the provided techniques. The examples disclosed hereby advantageously address the long-felt industry needs, as well as other previously unidentified needs, and mitigate shortcomings of conventional techniques.

Numerous examples are disclosed in this application's text and drawings. Alternate examples can be devised without departing from the scope of this disclosure. Additionally, conventional elements of the current teachings may not be described in detail, or may be omitted, to avoid obscuring aspects of the current teachings.

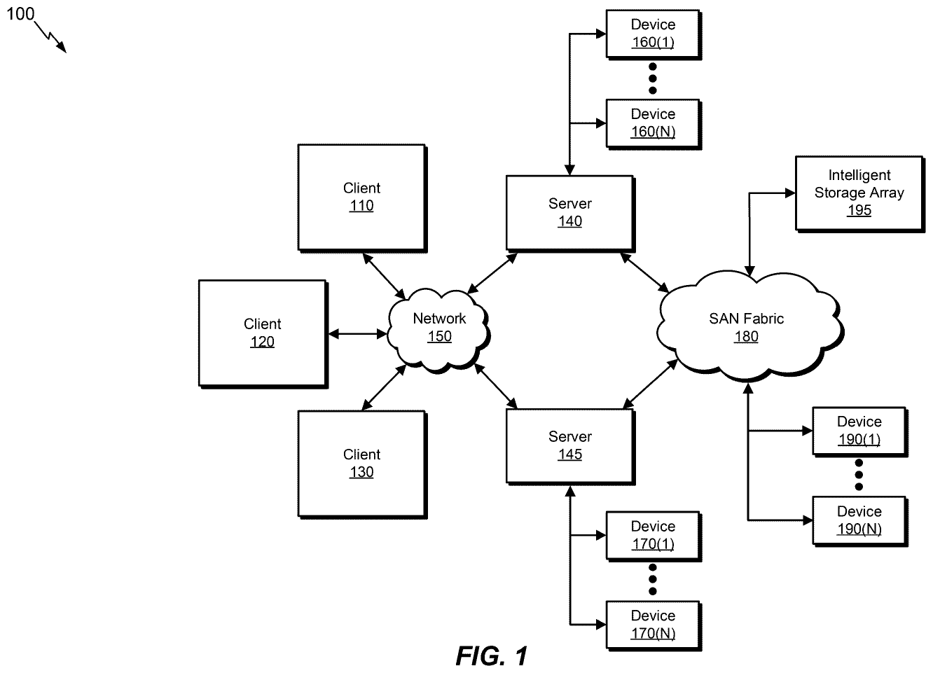

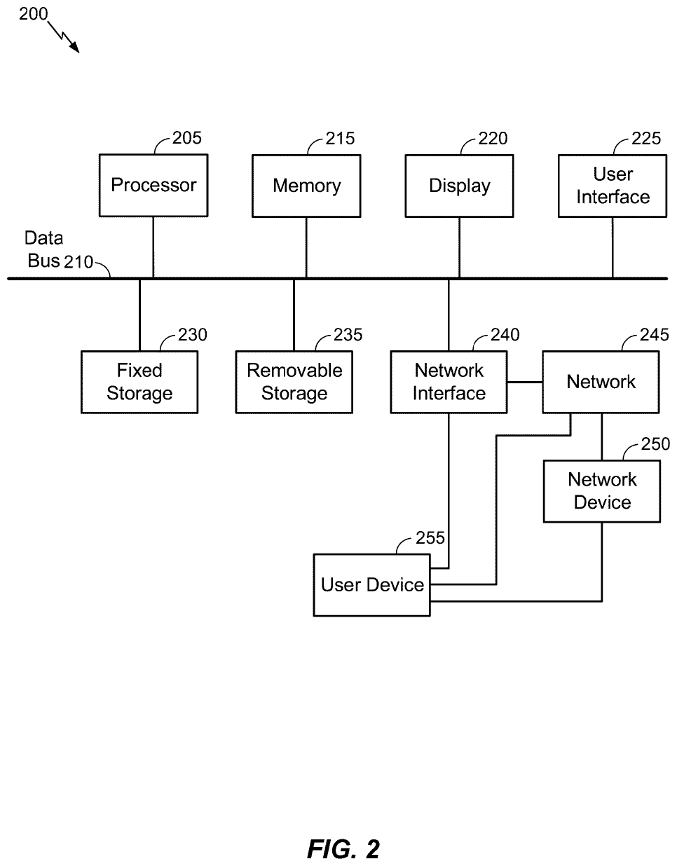

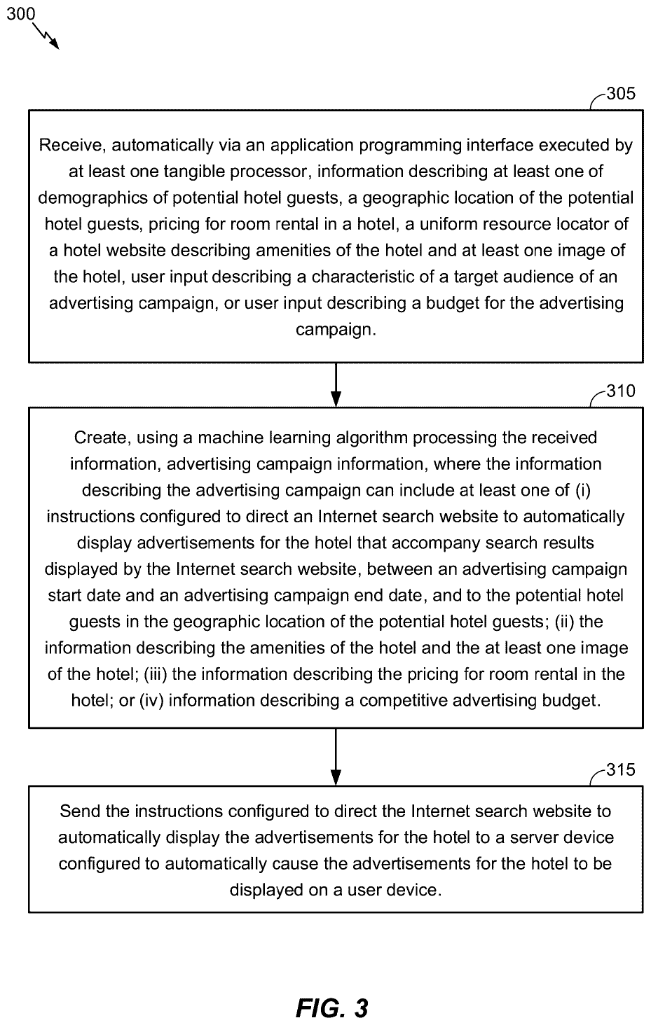

This description provides, with reference to FIGS. 1 and 2, detailed descriptions of example apparatus for scheduling automated information delivery to a user device. Detailed descriptions of example methods are provided in connection with FIGS. 3 to 12B.

FIG. 1 depicts a block diagram of an example network architecture 100 in which client systems 110, 120, and 130 and servers 140 and 145 can be coupled to a network 150. All or a portion of network architecture 100 can perform and/or be a means for performing, either alone or in combination with other elements, one or more of the steps disclosed herein (such as one or more of the steps illustrated in FIG. 3). All or a portion of network architecture 100 can also be used to perform and/or be a means for performing other steps and features set forth in the present disclosure.

Client systems 110, 120, and 130 generally represent any type or form of computing device or system, such as example computing system 200 in FIG. 2. Similarly, servers 140 and 145 generally represent computing devices or systems, such as application servers or database servers, configured to provide various database services and/or run certain software applications. Network 150 generally represents any telecommunication or computer network including, for example, an intranet, a WAN, a LAN, a PAN, and/or the Internet. In an example, client systems 110, 120, and/or 130 and/or servers 140 and/or 145 can include all or a portion of example computing system 200 from FIG. 2.

As illustrated in FIG. 1, one or more storage devices 160(1)-(N) can be directly attached to server 140. Similarly, one or more storage devices 170(1)-(N) can be directly attached to server 145. Storage devices 160(1)-(N) and storage devices 170(1)-(N) generally represent any type or form of storage device or medium capable of storing data and/or other computer-readable instructions. In certain embodiments, storage devices 160(1)-(N) and storage devices 170(1)-(N) can represent Network-Attached Storage (NAS) devices configured to communicate with servers 140 and 145 using various protocols, such as Network File System (NFS), Server Message Block (SMB), and/or Common Internet File System (CIFS).

Servers 140 and 145 can also be connected to a Storage Area Network (SAN) fabric 180. SAN fabric 180 generally represents any type or form of computer network or architecture capable of facilitating communication between a plurality of storage devices. SAN fabric 180 can facilitate communication between servers 140 and 145 and a plurality of storage devices 190(1)-(N) and/or an intelligent storage array 195. SAN fabric 180 can also facilitate, via network 150 and servers 140 and 145, communication between client systems 110, 120, and 130 and storage devices 190(1)-(N) and/or intelligent storage array 195 in such a manner that devices 190(1)-(N) and array 195 appear as locally attached devices to client systems 110, 120, and 130. As with storage devices 160(1)-(N) and storage devices 170(1)-(N), storage devices 190(1)-(N) and intelligent storage array 195 generally represent any type or form of storage device or medium capable of storing data, instructions, and/or other computer-readable instructions.

In certain embodiments, and with reference to example computing system 200 of FIG. 2, a communication interface, such as network interface 240 in FIG. 2, can be used to provide connectivity between each client system 110, 120, and 130 and network 150. Client systems 110, 120, and 130 can be able to access information on server 140 or 145 using, for example, a web browser or other client software. Such software can allow client systems 110, 120, and 130 to access data hosted by server 140, server 145, storage devices 160(1)-(N), storage devices 170(1)-(N), storage devices 190(1)-(N), and/or intelligent storage array 195. Although FIG. 1 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein can be encoded as a computer program and loaded onto and executed by server 140, server 145, storage devices 160(1)-(N), storage devices 170(1)-(N), storage devices 190(1)-(N), intelligent storage array 195, computing device 200, network device 250, user device 255, or any combination thereof. In some examples, all or a portion of one or more of the example embodiments disclosed herein can also be encoded as a computer program, stored in server 140, run by server 145, and distributed to client systems 110, 120, and 130 over network 150.

As detailed herein, computing device 200 and/or one or more components of network architecture 100 can perform and/or be a means for performing, either alone or in combination with other elements, one or more steps of an example method for scheduling automated information delivery to a user device.

FIG. 2 illustrates the example computing device 200 suitable for implementing examples of the disclosed subject matter. In examples, aspects of the computing device 200 can be implemented at least in part in a desktop computer, a laptop computer, a server, a mobile device, a special-purpose computer, a non-generic computer, an electronic device described hereby (as is practicable), the like, or a combination thereof. In some examples, the disclosed subject matter can be implemented in, and used with, hardware devices, computer network devices, the like, or a combination thereof. The configuration depicted in FIG. 2 is an illustrative example and is not limiting.

In some examples, the computing device 200 can include a processor 205, a data bus 210, a memory 215, a display 220, a user interface 225, a fixed storage device 230, a removable storage device 235, a network interface 240, a network 245, a network device 250, a user device 255, the like, or a combination thereof. These elements are described in further detail herein.

The processor 205 can be a hardware-implemented processing unit configured to control at least a portion of operation of the computing device 200. The processor 205 can perform logical and arithmetic operations based on processor-executable instructions stored within the memory 215. The processor 205 can be configured to execute instructions which cause the processor 205 to initiate at least a part of a method described hereby. In an example, the processor 205 can interpret instructions stored in the memory 215 to initiate at least a part of a method described hereby. In an example, the processor 205 can execute instructions stored in the memory 215 to initiate at least a part of a method described hereby. The instructions, when executed by the processor 205, can transform the processor 205 into a special-purpose processor that causes the processor to perform at least a part of a function described hereby. The processor 205 can also be referred to as a central processing unit (CPU), a special-purpose processor (e.g., a non-generic processor), or both.

The processor 205 can comprise or be a component of a physical processing system implemented with one or more processors. In some examples, the processor 205 can be implemented with at least a portion of: a microprocessor, a microcontroller, a digital signal processor (DSP) integrated circuit, a field programmable gate array (FPGA), a programmable logic device (PLD), an application-specific integrated circuit (ASIC), a controller, a state machine, a gated logic circuit, a discrete hardware component, a dedicated hardware finite state machine, a suitable physical device configured to manipulate information (e.g., calculating, logical operations, the like, or a combination thereof), the like, or a combination thereof.

The data bus 210 can couple components of the computing device 200. The data bus 210 can enable information communication between the processor 205 and one or more components coupled to the processor 205. In some examples, the data bus 210 can include a data bus, a power bus, a control signal bus, a status signal bus, the like, or a combination thereof. In an example, the components of the computing device 200 can be coupled together to communicate with each other using a different suitable mechanism.

The memory 215 generally represents any type or form of volatile storage device, non-volatile storage device, medium, the like, or a combination thereof. The memory 215 can store data, processor-readable instructions, the like, or a combination thereof. In an example, the memory 215 can store data, load data, maintain data, or a combination thereof. In an example, the memory 215 can store processor-readable instructions, load processor-readable instructions, maintain processor-readable instructions, or a combination thereof. In some embodiments, the memory 215 can store computer-readable instructions configured to cause a processor (e.g., the processor 205) to initiate performing at least a portion of a method described hereby. The memory 215 can be a main memory configured to store an operating system, an application program, the like, or a combination thereof. The memory 215 can be configured to store a basic input-output system (BIOS) which can control basic hardware operation such as interaction of the processor 205 with peripheral components. The memory 215 can also include a non-transitory machine-readable medium configured to store software. Software can mean any type of instructions, whether referred to as at least one of software, firmware, middleware, microcode, hardware description language, the like, or a combination thereof. Processor-readable instructions can include code (e.g., in source code format, in binary code format, executable code format, or in any other suitable code format).

The memory 215 can include at least one of read-only memory (ROM), random access memory (RAM), a flash memory, a cache memory, an erasable programmable read-only memory (EPROM), an electrically erasable programmable read-only memory (EEPROM), a register, a hard disk drive (HDD), a solid-state drive (SSD), an optical disk drive, other memory, the like, or a combination thereof which is configured to store information (e.g., data, processor-readable instructions, software, the like, or a combination thereof) and is configured to provide the information to the processor 205.

The display 220 can include a component configured to visually convey information to a user of the computing device 200. In examples, the display 220 is a video display screen, such as a light-emitting diode (LED) screen.

The user interface 225 can include user devices such as a switch, a keypad, a touch screen, a microphone, a speaker, an audio reproduction device, a jack for coupling the computing device to an audio reproduction device, the like, or a combination thereof. The user interface 225 can optionally include a user interface controller. The user interface 225 can include a component configured to convey information to a user of the computing device 200, a component configured to receive information from the user of the computing device 200, or both.

The fixed storage device 230 can include one or more hard drives, flash storage devices, the like, or a combination thereof. The fixed storage device 230 can be an information storage device which is not configured to be removed during use. The fixed storage device 230 can optionally include a fixed storage device controller. The fixed storage device 230 can be integral with the computing device 200 or can be separate and accessed through an interface.

The removable storage device 235 can be integral with the computing device 200 or can be separate and accessed through other interfaces. The removable storage device 235 can be an information storage device which is configured to be removed during use, such as a memory card, a jump drive, a flash storage device, an optical disk, the like, or a combination thereof. The removable storage device 235 can optionally include a removable storage device controller. The removable storage device 235 can be integral with the computing device 200 or can be separate and accessed through an interface.

In examples, a computer-readable storage medium such as one or more of the memory 215, the fixed storage device 230, the removable storage device 235, a remote storage location, the like, or a combination thereof can store non-transitory computer-executable instructions configured to cause a processor (e.g., the processor 205) to implement at least an aspect of the present disclosure.

The network interface 240 can couple the processor 205 (e.g., via the data bus 210) to the network 245 and enable exchanging information between the processor 205 and the network 245. In some examples, the network interface 240 can couple the processor 205 (e.g., via the data bus 210) to the network 245 and enable exchanging information between the processor 205 and the user device 255. For example, the network interface 240 can enable the processor 205 to communicate with one or more other network devices 250. The network interface 240 can couple to the network 245 using any suitable technique and any suitable protocol. In some examples, the network interface 240 can include a data bus, a power bus, a control signal bus, a status signal bus, the like, or a combination thereof. Example techniques and protocols the network interface 240 can be configured to implement include digital cellular telephone, WiFi™, Bluetooth®, near-field communications (NFC), the like, or a combination thereof.

The network 245 can couple the processor 205 to one or more other network devices, such as a user device 255. In some examples, the network 245 can enable exchange of information between the processor 205 and the one or more other network devices 250. In some examples, the network 245 can enable exchange of information between the processor 205 and the user device 255. The network 245 can include one or more private networks, local networks, wide-area networks, the Internet, other communication networks, the like, or a combination thereof. In some examples, the network 245 can be a wired network, a wireless network, an optical network, the like, or a combination thereof.

In some embodiments, the network device 250 can store computer-readable instructions configured to cause a processor (e.g., the processor 205) to initiate performing at least a portion of a method described hereby. In an example, the one or more other network devices 250 can store non-transitory computer-executable instructions configured to cause a processor (e.g., the processor 205) to implement at least an aspect of the present disclosure. The non-transitory computer-executable instructions can be received by the processor 205 and implemented using at least a portion of techniques described hereby.

In another example, information described hereby can be stored in the fixed storage device 230, the removable storage device 235, the network device 250, the like, or a combination thereof.

The network device 250 can be a user device, a hardware device configured to couple the network 245 to the user device 255, a server, a digital information storage device, the like, or a combination thereof.

In some examples, the network device 250 can include user devices such as a switch, a keypad, a touch screen, a microphone, a speaker, an audio reproduction device, a jack for coupling the computing device to an audio reproduction device, the like, or a combination thereof. The network device 250 can optionally include a user interface controller. The network device 250 can include a component configured to convey information to a user of the computing device 200, a component configured to receive information from the user of the computing device 200, or both.

The user device 255 can be, for example, a desktop computer, a laptop computer, a mobile device, a tablet computer, a cellular phone, a body-worn computing device, the like, or a combination thereof. The user device 255 can include a respective processor, a respective bus, a respective memory (such as random-access memory (RAM), read-only memory (ROM), flash RAM, the like, or a combination thereof), a respective video display (such as a display screen configured to visually convey information, such as advertisements for a hotel to a user of the user device 255), a respective user input interface device (which can include one or more controllers and associated user input devices such as a keyboard, mouse, touch screen, the like, or a combination thereof), a respective fixed storage device (such as a hard drive, flash storage, the like, or a combination thereof), a respective removable media device (operative to control and receive an optical disk, flash drive, the like, or a combination thereof), a network interface device operable to communicate with one or more remote devices (e.g., a server device) via a suitable network connection, or a combination thereof.

Example techniques and protocols the user device 255 can be configured to implement to connect to the one or more remote devices include digital cellular telephone, WiFi™, Bluetooth®, near-field communications (NFC), the like, or a combination thereof.

In some examples, all the components illustrated in FIG. 2 need not be present to practice the present disclosure. Further, the components can be coupled in different ways from those illustrated.

FIG. 3 depicts an example method 300 for scheduling automated information delivery to a user device. The method 300 can be performed by the apparatus described hereby, such as the example network architecture 100 in FIG. 1, the computing device 200 in FIG. 2, or a practicable combination thereof.

As illustrated in FIG. 3, at block 305, one or more of the devices described herein can receive information describing at least one of demographics of potential hotel guests, a geographic location of the potential hotel guests, pricing for room rental in a hotel, a uniform resource locator (URL) of a hotel website, user input describing a characteristic of a target audience of the advertising campaign, or user input describing a budget for the advertising campaign. In some embodiments, the information received at block 305 can be automatically received via an application programming interface (API) executed by the at least one tangible processor.

In some nonlimiting embodiments, information received at block 305 can include demographic details describing the hotel, such as at least one of the hotel being a boutique, the hotel being a hostel, the hotel being part of a chain, a star rating of the hotel, a review of the hotel, an address of the hotel, or a postal code of the hotel.

In some examples, information received at block 305 can include demographic details describing a potential hotel guest in a target market, such as at least one of a business traveler, a vacation traveler, a search history (e.g. via an Internet browser cookie), Internet search engine personal advertising data, a family size, and income band, an address of the potential hotel guest, or a postal code of the potential hotel guest.

In some examples, information received at block 305 can include geographic details describing at least one of the address of the hotel, the postal code of the hotel, the address of the potential hotel guest, or the postal code of the potential hotel guest.

In some examples, information received at block 305 can include behavioral details of a potential hotel guest, such as at least one of a search history, topics of interest, search results presented to the potential hotel guest describing attractions that are geographically local to the hotel, previous travel of the potential hotel guest, or a booking history of the potential hotel guest.

In some nonlimiting examples, information received by the API can include a search history of the potential hotel guest, a search action of the potential hotel guest, a guest profile of the potential hotel guest, demographic information describing the potential hotel guest, a room rate of the hotel, information describing competitive pricing provided by an online travel agency, or a potential hotel guest profile (e.g. provided via Google API tools).

In some examples, information received at block 305 can include at least one of search engine optimization data, online travel agency data, a current room occupancy of the hotel, or event activity that is geographically local to the hotel.

In some examples, the hotel website can send, to the one or more of the devices described herein, the information describing amenities of the hotel, at least one image of the hotel, or both.

In some embodiments, the method 300 can further include retrieving, using the uniform resource locator, information describing the amenities of the hotel, the at least one image of the hotel, or both.

In some examples, information received at block 305 can include standard room and hotel stock images, as well as images of attractions that are geographically local to the hotel.

In some examples, the method 300 can include analyzing information received at block 305 to identify at least one of a key word, a website type, click-through activity, meta-tagging, or recency of content.

In some examples, the method 300 can further include at least one of (i) receiving, via a user interface device, additional campaign information describing an advertising campaign name and an advertising campaign description; (ii) associating the received additional campaign information with the advertising campaign information; (iii) storing, in a tangible non-transient storage device, the received additional campaign information with the advertising campaign information; or (iv) retrieving, from the tangible non-transient storage device, the received additional campaign information, the advertising campaign information, or both.

As illustrated in FIG. 3, at block 310, one or more of the devices described herein can create, using a machine learning algorithm processing the received information (e.g., the information received in block 305 by the one or more of the devices described herein), advertising campaign information. The information describing the advertising campaign can include at least one of (i) instructions configured to direct an Internet-accessible website (e.g., an Internet search website) to automatically display advertisements for the hotel (e.g., that accompany search results displayed by the Internet search website), between an advertising campaign start date and an advertising campaign end date, and to the potential hotel guests in the geographic location of the potential hotel guests; (ii) the information describing the amenities of the hotel; (iii) the information describing the at least one image of the hotel; (iv) the information describing the pricing for room rental in the hotel; or (v) information describing a competitive advertising budget.

In some examples, the machine learning algorithm can be configured to evaluate market data in real-time across competitive properties in a market and make recommendations to a user (e.g. a property owner) about a room rate and a pricing strategy for the advertising campaign. The machine learning algorithm can also be dynamically updated if the user so chooses.

In some examples, the advertising campaign can be directed towards target audiences such as business travelers, families, individuals, military, groups that have specific counter discount program (CDP) codes, and providing no additional program discounts other than mentioning loyalty card info, when applicable.

In some examples, the machine learning algorithm can be configured to evaluate hotel and competitor hotel content and website tagging to determine an effectiveness rank. Based on this rank, different advertising investment strategies are recommended. Targeting of various guest types by the advertising campaign can occur based on view rates. The machine learning algorithm can dynamically adjust room rates based on at least one of views, occupancy, or competitor rates. Targeted advertisements can be specific to the potential guest of the hotel who is searching for a room. In examples, the user device can display an advertisement highlighting and describing local attractions. In other examples, the user device can display an advertisement relating to travel promotions based on a profile of the potential guest of the hotel.

In some embodiments, the campaign strategy can include a start date and an end date for displaying an advertisement on a user device. In examples, the campaign strategy can include perpetually displaying an advertisement on the user device.

In some examples, campaign strategy can include an advertisement. The advertisement can include at least one of an image of the hotel, an image of a room in the hotel, or an image of an attraction that is locally geographic to the hotel. In some examples, the advertisement can include a written description of at least one of an image of the hotel, an image of a room in the hotel, or an image of an attraction that is locally geographic to the hotel. The advertisement can include uniform resource locator of a website of the hotel by which a perspective hotel guest can book a reservation at the hotel.

In some examples, the campaign strategy can generate a report recommending at least one change to the campaign strategy.

In some examples, the method 300 can further include at least one of (i) receiving, via a user interface device, user profile information describing at least one of a username, a user email address, a user company, or the uniform resource locator of the hotel website; (ii) receiving, via the user interface device, information confirming the user profile information; (iii) storing, in response to the receiving the information confirming the user profile information, the user profile information in a tangible non-transient storage device; (iv) retrieving the user profile information from the tangible non-transient storage device; or (v) enabling the creating the advertising campaign information in response to the receiving the information confirming the user profile information.

In some examples, the method 300 can further include receiving, from a user interface device, an instruction to initiate performing the creating the advertising campaign information step.

In some examples, the method 300 can further include displaying, on a display of the user device, information describing at least one of an advertising campaign name; the advertising campaign start date; the advertising campaign end date; the budget for the advertising campaign; an amount of funds spent to date on the advertising campaign; a total number of advertisements in the advertising campaign; a number of user inputs received to date as a result of the advertising campaign; or a campaign calendar identifying the advertising campaign start date, the advertising campaign end date, and all dates therebetween.

In some examples, the method 300 can further include displaying, on a display of the user device, different levels of investment in the campaign strategy. In a nonlimiting example, names can be provided to the different levels of investment to identify the different levels of investment. The names can be based upon a ratio of investment in advertising to achieve a desired outcome and occupancy rate. In some examples, investing more can increase a ranking of the hotel and increase a number of direct bookings of rooms in the hotel.

In some examples, the method 300 can further include displaying, on a screen of the user device, information describing at least one of (i) a campaign calendar identifying the advertising campaign is unpaid for or (ii) a request for payment information.

In some examples, the campaign calendar can indicate dates during which a specific advertising campaign is to take place by highlighting days, weeks, months, or combination thereof on the campaign calendar. An advertising campaign that is unpaid for can be indicated using a highlighting color other than that used to generally indicate dates of advertising campaigns.

In some examples, the machine learning algorithm can be trained with training information configured to cause machine learning algorithm to be configured to perform at least one function, step, feature, or block described herein. In some examples, the method 300 can include training the machine learning algorithm with training information configured to cause machine learning algorithm to be configured to perform at least one function, step, feature, or block described herein. In some examples, the machine learning algorithm can be trained with training information configured to cause machine learning algorithm to be configured to perform at least a portion of scheduling automated information delivery to a user device.

In some examples, the machine learning algorithm training can be improved upon at least in part based on search results, booking results, or combination thereof.

As illustrated in FIG. 3, at block 315, one or more of the devices described herein can send the instructions configured to direct the Internet search website to automatically display the advertisements for the hotel to a server device configured to automatically cause the advertisements for the hotel to be displayed on the user device. In some examples, the instructions can be sent to an API of the server device. In some examples, the server device can cause an advertisement for the hotel to be displayed on a website image that is displayed on a display of the user device. In some examples, the server device can send a text message to the user device, where the text message displays an advertisement for the hotel to be displayed on a display of the user device.

In some examples, characteristics of campaign results that are analyzed to determine campaign performance can include effectiveness measures such as views, click throughs, action completions, an advertising rank, an advertising placement, a revenue per room increase, a revenue per room, an occupancy rates increase, or an occupancy rate increase.

The blocks in FIG. 3 are not limiting of the examples. In some examples, the blocks can be combined, the order can be rearranged, or both, as practicable.

As detailed above, the steps outlined in method 300 in FIG. 3 and the examples of FIGS. 1-2 and 4-12B provide systems and methods for scheduling automated information delivery to a user device. By doing so, the systems and methods described herein improve functioning of computing devices by providing more efficient techniques for scheduling automated information delivery to a user device, when compared to conventional techniques. In some embodiments, the systems and methods described herein can improve functioning of computing devices by managing information in a manner that enables more time-efficient techniques for scheduling automated information delivery to a user device, when compared to conventional techniques, thus reducing information processing times, reducing processor cycles, reducing Internet traffic (e.g., to online travel agencies), and reducing information storage requirements.

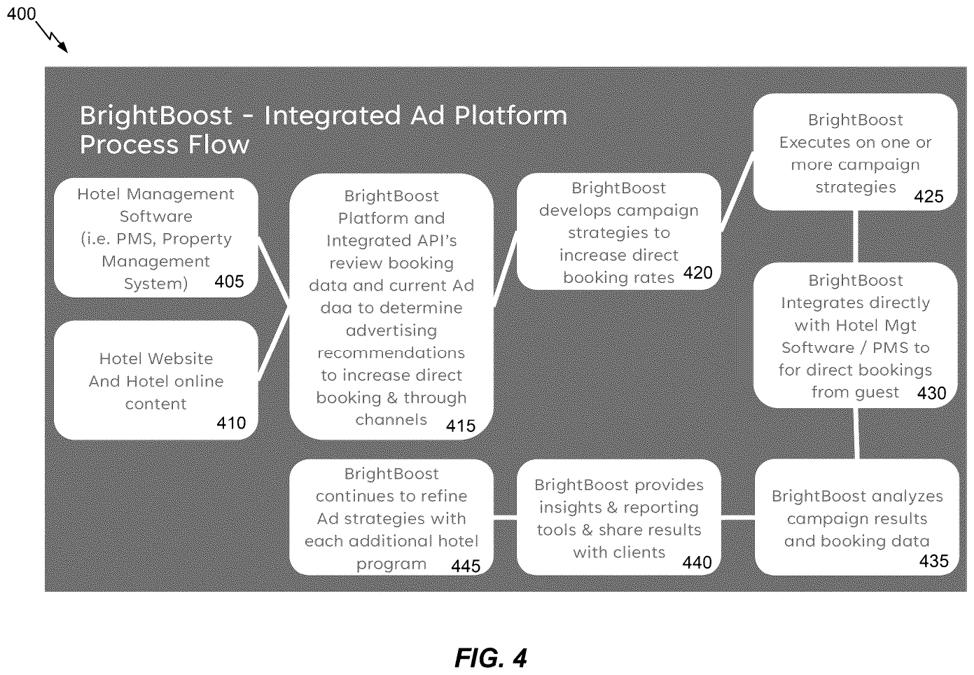

FIG. 4 depicts an example process flow 400 of an example method for scheduling automated information delivery to a user device. The example process flow 400 includes block 405, in which hotel management software is configured to provide detailed information about the hotel to block 415. Block 410 depicts a hotel website and other information describing details about the hotel that are online, that is configured to provide detailed information about the hotel to block 415.

Block 415 depicts processing and analysis of information received (e.g. such as that received in block 305 in FIG. 3) that determines advertising recommendations for inclusion in an advertising campaign.

Block 420 depicts using results of analysis performed at block 415 to develop at least one advertising campaign strategy. Developing the at least one advertising campaign strategy can include performing block 310 in FIG. 3.

Block 425 depicts execution of at least one advertising campaign strategy. Execution of an advertising campaign strategy can include performing block 315 in FIG. 3.

Block 430 depicts at least one of the systems described herein communicating directly with a server executing hotel management software. Information communicated can include information describing click-throughs on hotel and advertisements displayed on a user device, a number of bookings resulting from the at least one advertising campaign other feedback from the server executing the hotel management software, or combination thereof.

Block 435 depicts analyzing information describing advertising campaign results and reservation booking to identify effectiveness of at least one advertising campaign.

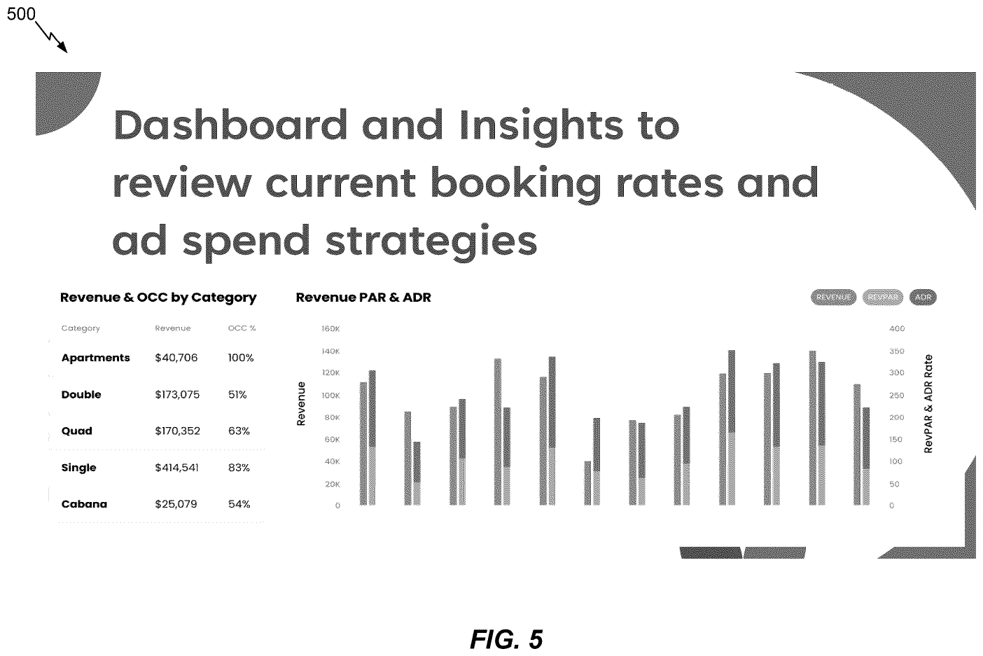

Block 440 depicts providing information describing feedback, such as via the dashboard display depicted in FIG. 5. In examples, the information describing the feedback can be displayed on a user display device.

Block 445 depicts using the information describing the feedback from block 440 to refine training of the machine learning algorithm.

FIG. 5 depicts an example user interface screen 500 depicting a dashboard display of booking rates and advertising expenses. The dashboard display can display information such as revenue by type of hotel room, occupancy rate by type of hotel room, revenue per available room, average daily rate, or combination thereof.

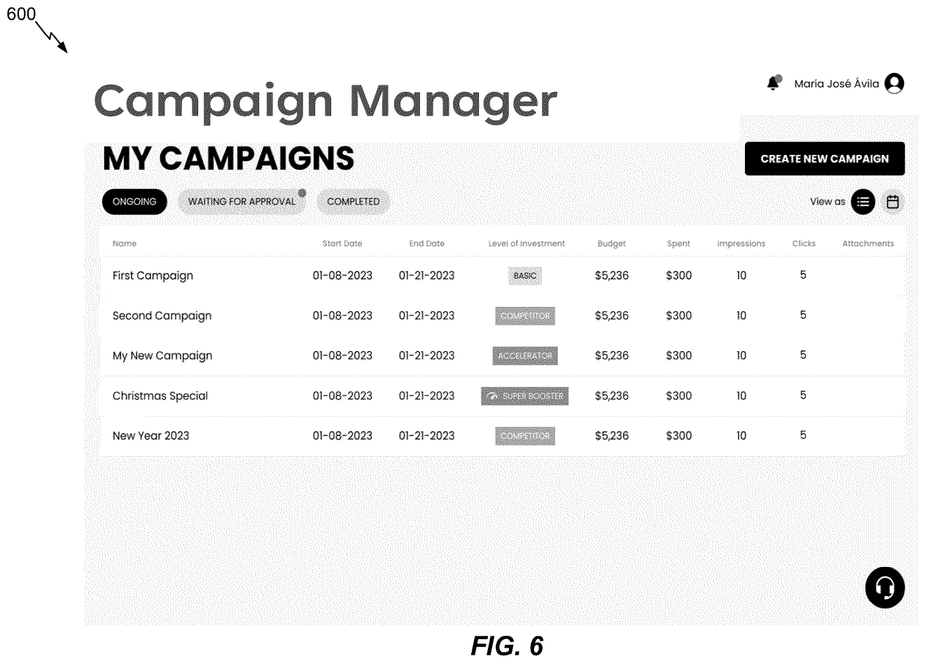

FIG. 6 depicts an example user interface screen 600 depicting a display of an advertising campaign manager. The campaign manager display can display information such as an advertising campaign name, a respective campaign start date, a respective campaign end date, a level of investment in the respective advertising campaign, a budget of the respective advertising campaign, an amount spent to date on the respective advertising campaign, a number of advertisements displayed on at least one user device during the advertising campaign, a number of click-throughs on the advertisements displayed during the advertising campaign, or combination thereof.

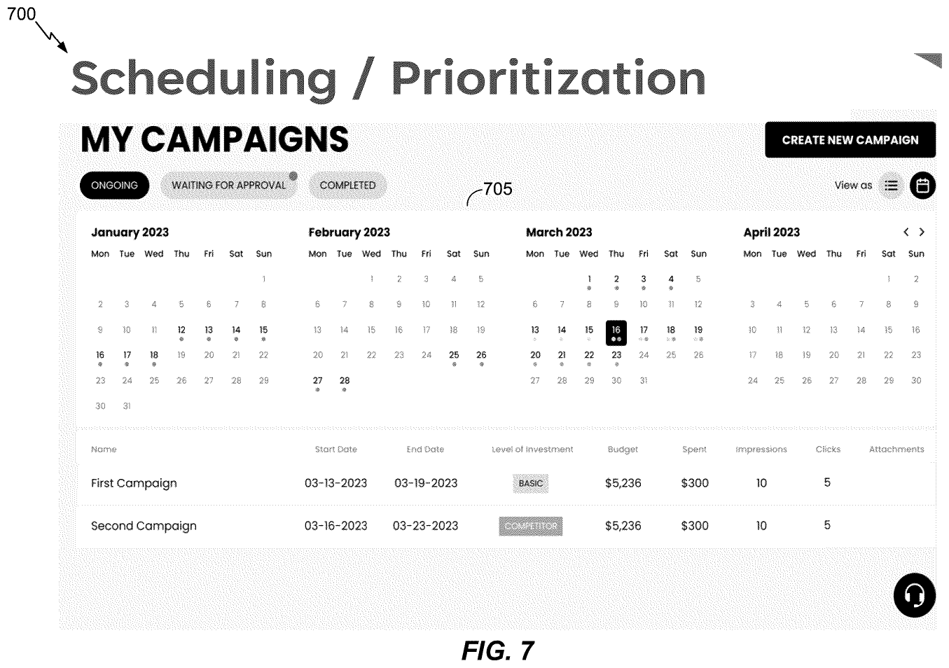

FIG. 7 depicts an example user interface screen 700 depicting a display of an advertising campaign scheduling calendar 705. The advertising campaign scheduling calendar 705 can display information such as days and months in which an advertising campaign is scheduled, an advertising campaign name, a respective campaign start date, a respective campaign end date, a level of investment in the respective advertising campaign, a budget of the respective advertising campaign, an amount spent to date on the respective advertising campaign, a number of advertisements displayed on at least one user device during the advertising campaign, a number of click-throughs on the advertisements displayed during the advertising campaign, or combination thereof.

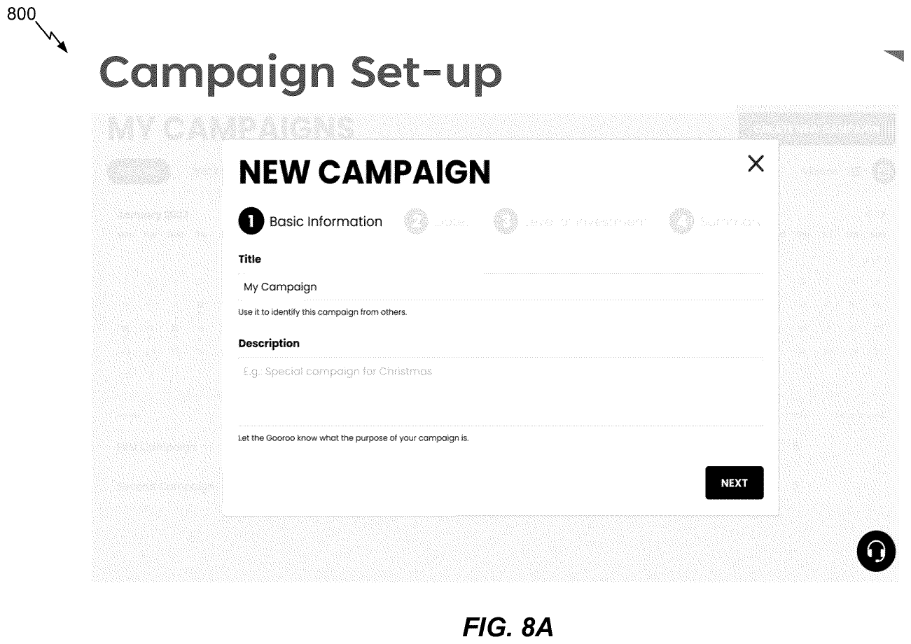

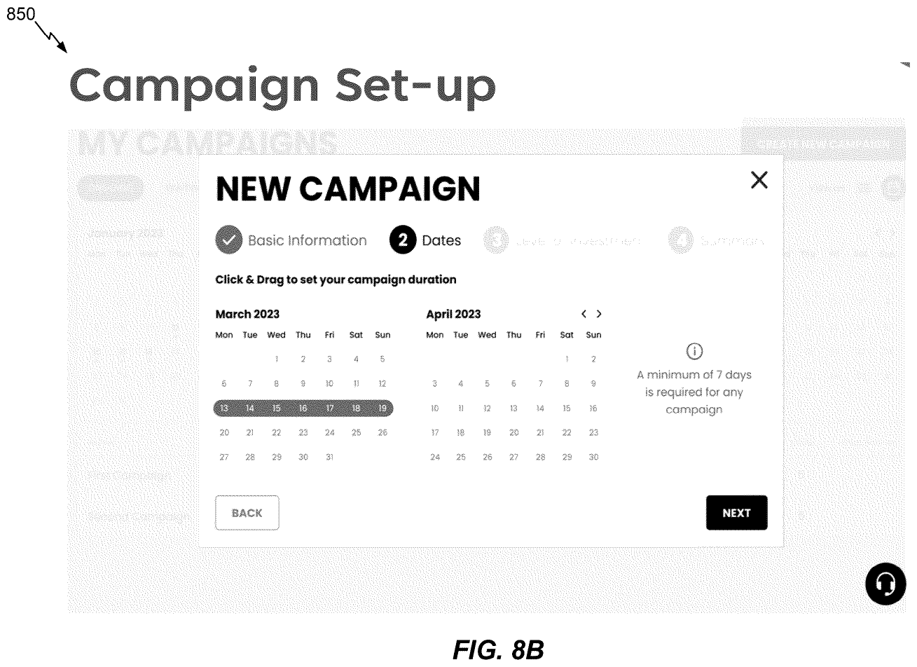

FIG. 8A depicts an example user interface screen 800 configured to display and to receive user input information describing basic information about a new advertising campaign. In an example, information received from a user can serve as information received in block 305. The user interface screen 800 can include a request for basic information about the new advertising campaign, such as a title of the new advertising campaign, a description of the new advertising campaign, or both. The user interface screen 800 can receive basic information about the new advertising campaign, such as the title of the new advertising campaign, the description of the new advertising campaign, or both.

FIG. 8B depicts an example user interface screen 850 configured to display and to receive user input information describing advertising campaign start and end dates of an advertising campaign. In an example, information received from a user can serve as information received in block 305. The user interface screen 850 can include a request for a start date of the new advertising campaign, an end date of the new advertising campaign, and dates therebetween. The user interface screen 850 can receive information describing the start date of the new advertising campaign, the end date of the new advertising campaign, and dates therebetween.

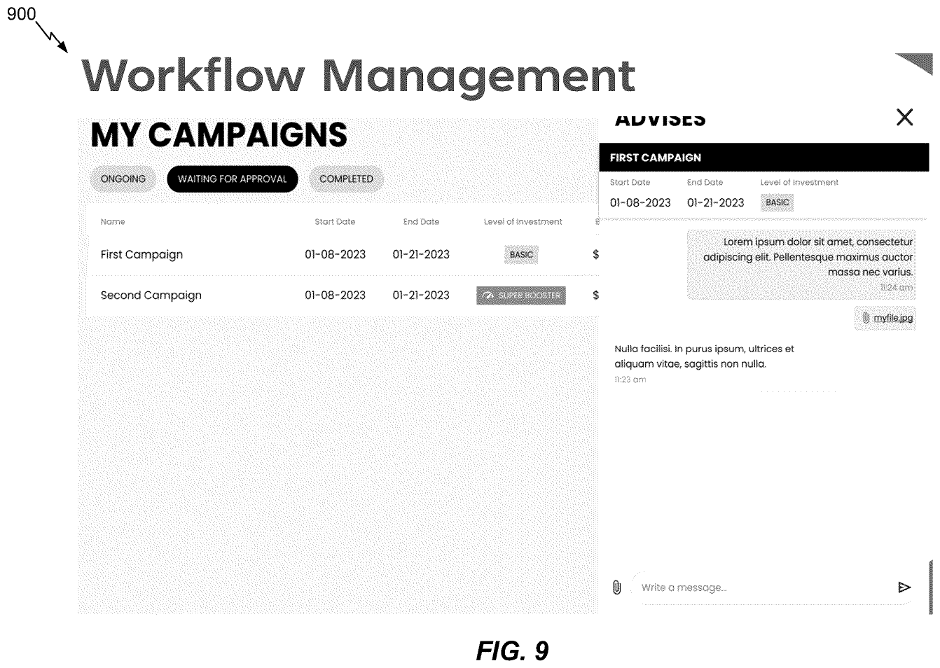

FIG. 9 depicts an example user interface screen 900 configured to display and receive information describing details about at least one advertising campaign. In examples, the user interface screen 900 can depict an advertising campaign name, a respective campaign start date, a respective campaign end date, a level of investment in the respective advertising campaign, a budget of the respective advertising campaign, an amount spent to date on the respective advertising campaign, a number of advertisements displayed on at least one user device during the advertising campaign, a number of click-throughs on the advertisements displayed during the advertising campaign, or combination thereof. User interface screen 900 can depict whether an advertising campaign is ongoing, waiting for approval, or completed.

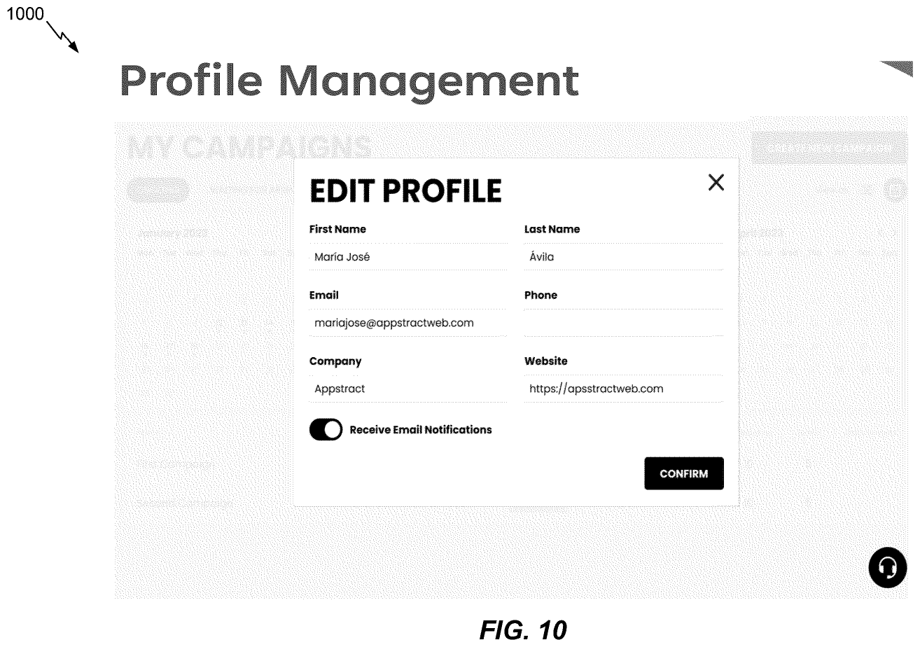

FIG. 10 depicts an example user interface screen 1000 configured to display and receive information describing a user profile. The user interface screen 1000 can be configured to depict profile information such as, and not limited to, a first name of user, a last name of user, an email address of the user, a phone number of the user, a company associated with the user, a website associated with the user, or a combination thereof. The user interface screen 1000 can be configured to receive profile information such as, and not limited to, the first name of user, the last name of user, the email address of the user, the phone number of the user, the company associated with the user, the website associated with the user, or the combination thereof. Information received via the user interface screen 1000 can be stored in a tangible non-transient storage device, retrieved from the tangible non-transient storage device, or a combination thereof. In examples, presence of the user profile enables execution of at least a portion of the method 300. In examples, absence of the user profile disables execution of the least the portion of the method 300. In further example, the email address of the user is the URL of the hotel website.

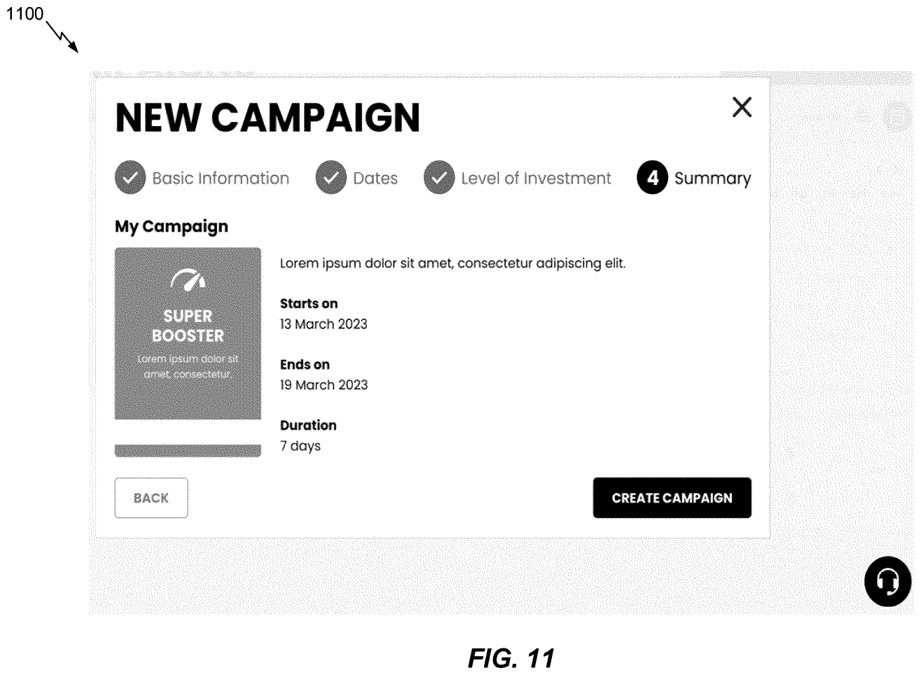

FIG. 11 depicts an example user interface screen 1100 configured to display and receive information describing at least one advertising campaign. The user interface screen 1100 can be configured to depict a screen indicating completion of receipt of at least a portion of user input information describing features of advertising campaign. The user interface screen 1100 can be configured to receive information initiating creating an advertising campaign. In some examples, the information initiating creating an advertising campaign can initiate block 310.

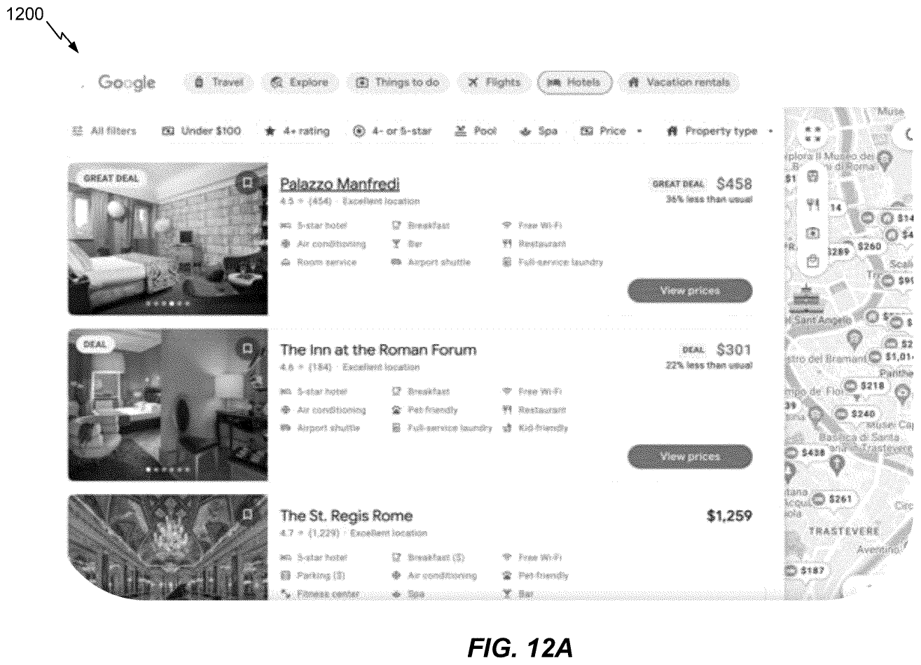

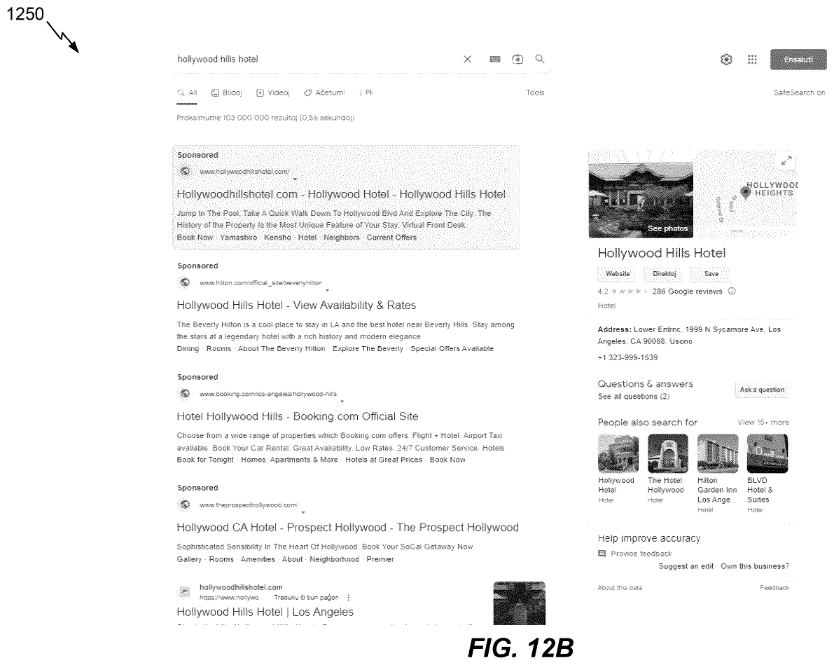

FIG. 12A depicts an example user device display screen 1200 configured to display, on a user device display and in conjunction with displaying a map, an advertisement that is part of an advertising campaign (e.g. created by block 310).

FIG. 12B depicts an example user device display screen 1250 configured to display, on a user display device and as part of advertising being displayed in conjunction with search results provided by a search engine, an advertisement that is part of an advertising campaign (e.g. created by block 310).

As used hereby, the term “example” means “serving as an example, instance, or illustration”. Any example described as an “example” is not necessarily to be construed as preferred or advantageous over other examples. Likewise, the term “examples” does not require all examples include the discussed feature, advantage, or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures. Moreover, at least a portion of the apparatus described hereby can be configured to perform at least a portion of a method described hereby.

It should be noted the terms “connected,” “coupled,” and any variant thereof, mean any connection or coupling between elements, either direct or indirect, and can encompass a presence of an intermediate element between two elements which are “connected” or “coupled” together via the intermediate element. Coupling and connection between the elements can be physical, logical, or a combination thereof. Elements can be “connected” or “coupled” together, for example, by using one or more wires, cables, printed electrical connections, electromagnetic energy, and the like. The electromagnetic energy can have a wavelength at a radio frequency, a microwave frequency, a visible optical frequency, an invisible optical frequency, and the like, as practicable. These are several non-limiting and non-exhaustive examples.

The term “signal” can include any signal such as a data signal, an audio signal, a video signal, a multimedia signal, an analog signal, a digital signal, and the like. Information and signals described hereby can be represented using any of a variety of different technologies and techniques. For example, data, an instruction, a process step, a process block, a command, information, a signal, a bit, a symbol, and the like which are referred to hereby can be represented by a voltage, a current, an electromagnetic wave, a magnetic field, a magnetic particle, an optical field, an optical particle, and/or any practical combination thereof, depending at least in part on the particular application, at least in part on the desired design, at least in part on the corresponding technology, and/or at least in part on like factors.

A reference using a designation such as “first,” “second,” and so forth does not limit either the quantity or the order of those elements. Rather, these designations are used as a convenient method of distinguishing between two or more elements or instances of an element. Thus, a reference to first and second elements does not mean only two elements can be employed, or the first element must necessarily precede the second element. Also, unless stated otherwise, a set of elements can comprise one or more elements. In addition, terminology of the form “at least one of: A, B, or C” or “one or more of A, B, or C” or “at least one of the group consisting of A, B, and C” used in the description or the claims can be interpreted as “A or B or C or any combination of these elements”. For example, this terminology can include A, or B, or C, or A and B, or A and C, or A and B and C, or 2A, or 2B, or 2C, and so on.

The terminology used hereby is for the purpose of describing particular examples only and is not intended to be limiting. As used hereby, the singular forms “a,” “an,” and “the” include the plural forms as well, unless the context clearly indicates otherwise. In other words, the singular portends the plural, where practicable. Further, the terms “comprises,” “comprising,” “includes,” and “including,” specify a presence of a feature, an integer, a step, a block, an operation, an element, a component, and the like, but do not necessarily preclude a presence or an addition of another feature, integer, step, block, operation, element, component, and the like.

Those of skill in the art will appreciate the example logical blocks, elements, modules, circuits, and steps described in the examples disclosed hereby can be implemented individually and/or collectively, as electronic hardware, computer software, or combinations of both, as practicable. To clearly illustrate this interchangeability of hardware and software, example components, blocks, elements, modules, circuits, and steps have been described hereby generally in terms of their functionality. Whether such functionality is implemented as hardware or software depends upon the particular application and design constraints imposed on an overall system. Skilled artisans can implement the described functionality in different ways for each particular application, but such implementation decisions should not be interpreted as causing a departure from the scope of the present disclosure. In addition, any disclosure of components contained within other components should be considered example in nature since many other architectures can be implemented to achieve the same functionality.

At least a portion of the methods, sequences, algorithms or a combination thereof which are described in connection with the examples disclosed hereby can be embodied directly in hardware, in instructions executed by a processor (e.g., a processor described hereby), or in a combination thereof. In an example, a processor includes multiple discrete hardware components. Instructions can reside in a non-transient storage medium (e.g., a memory device), such as a random-access memory (RAM), a flash memory, a read-only memory (ROM), an erasable programmable read-only memory (EPROM), an electrically erasable programmable read-only memory (EEPROM), a register, a hard disk, a removable disk, a compact disc read-only memory (CD-ROM), any other form of storage medium, the like, or a combination thereof. An example storage medium (e.g., a memory device) can be coupled to the processor so the processor can read information from the storage medium, write information to the storage medium, or both. In an example, the storage medium can be integral with the processor.

Further, examples provided hereby are described in terms of sequences of actions to be performed by, for example, one or more elements of a computing device. The actions described hereby can be performed by a specific circuit (e.g., an application specific integrated circuit (ASIC)), by instructions being executed by one or more processors, or by a combination of both. Additionally, a sequence of actions described hereby can be entirely within any form of non-transitory computer-readable storage medium having stored thereby a corresponding set of computer instructions which, upon execution, cause an associated processor (such as a special-purpose processor) to perform at least a portion of a function described hereby. Additionally, a sequence of actions described hereby can be entirely within any form of non-transitory computer-readable storage medium having stored thereby a corresponding set of instructions which, upon execution, configure the processor to create specific logic circuits. Thus, examples can be in a number of different forms, all of which have been contemplated to be within the scope of the disclosure. In addition, for each of the examples described hereby, a corresponding electrical circuit of any such examples can be described hereby as, for example, “a logic circuit configured to” perform a described action.

In an example, when a general-purpose computer (e.g., a processor) is configured to perform at least a portion of a method described hereby, then the general-purpose computer becomes a special-purpose computer which is not generic and is not a general-purpose computer. In an example, loading a general-purpose computer with special programming can cause the general-purpose computer to be configured to perform at least a portion of a method described hereby. In an example, a combination of two or more related method steps disclosed hereby forms a sufficient algorithm. In an example, a sufficient algorithm constitutes special programming. In an example, special programming constitutes any software which can cause a computer (e.g., a general-purpose computer, a special-purpose computer, etc.) to be configured to perform one or more functions, features, steps algorithms, blocks, or a combination thereof, as disclosed hereby.

At least one example provided hereby can include a non-transitory (i.e., a non-transient) machine-readable medium and/or a non-transitory (i.e., a non-transient) computer-readable medium storing processor-executable instructions configured to cause a processor (e.g., a special-purpose processor) to transform the processor and any other cooperating devices into a machine (e.g., a special-purpose processor) configured to perform at least a part of a function described hereby, at least a part of a method described hereby, the like, or a combination thereof. Performing at least a part of a function described hereby can include initiating at least a part of a function described hereby, at least a part of a method described hereby, the like, or a combination thereof. In an example, execution of the stored instructions can transform a processor and any other cooperating devices into at least a part of an apparatus described hereby. A non-transitory (i.e., a non-transient) machine-readable medium specifically excludes a transitory propagating signal. Further, one or more examples can include a computer-readable medium embodying at least a part of a function described hereby, at least a part of a method described hereby, the like, or a combination thereof. A non-transitory (i.e., a non-transient) machine-readable medium specifically excludes a transitory propagating signal.

In some examples, at least a portion of example network architecture 100 in FIG. 1, at least a portion of example computing device 200 in FIG. 2, or both can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

Nothing stated or depicted in this application is intended to dedicate any component, step, block, element, feature, object, benefit, advantage, or equivalent to the public, regardless of whether the component, step, block, element, feature, object, benefit, advantage, or the equivalent is recited in the claims. While this disclosure describes examples, changes and modifications can be made to the examples disclosed hereby without departing from the scope defined by the appended claims. A feature from any of the provided examples can be used in combination with one another feature from any of the provided examples in accordance with the general principles described hereby. The present disclosure is not intended to be limited to the specifically disclosed examples alone.

What is claimed is:

1. A computer-implemented method for scheduling automated information delivery to a user device, at least a portion of the method being performed by a computing device comprising at least one tangible processor, the method comprising:
receiving, automatically via an application programming interface executed by the at least one tangible processor, information describing:
demographics of potential hotel guests;
a geographic location of the potential hotel guests;
pricing for room rental in the hotel;
a uniform resource locator of a hotel website describing amenities of the hotel and at least one image of the hotel;
user input describing a characteristic of a target audience of the advertising campaign; and
user input describing a budget for the advertising campaign;
creating, using a machine learning algorithm processing the received information, advertising campaign information, wherein the information describing the advertising campaign comprises:
instructions configured to direct an Internet search website to automatically display advertisements for the hotel that accompany search results displayed by the Internet search website, between an advertising campaign start date and an advertising campaign end date, and to the potential hotel guests in the geographic location of the potential hotel guests;
the information describing the amenities of the hotel and the at least one image of the hotel;
the information describing the pricing for room rental in the hotel; and
information describing a competitive advertising budget; and
sending the instructions configured to direct the Internet search website to automatically display the advertisements for the hotel to a server device configured to automatically cause the advertisements for the hotel to be displayed on the user device.

2. The computer-implemented method of claim 1, further comprising retrieving, using the uniform resource locator, the information describing the amenities of the hotel and the at least one image of the hotel.

3. The computer-implemented method of claim 1, further comprising receiving, from a user interface device, an instruction to initiate performing the creating the advertising campaign information step.

4. The computer-implemented method of claim 1, further comprising:
receiving, via a user interface device, user profile information describing:
a username;
a user email address;
a user company; and
the uniform resource locator of the hotel website;
receiving, via the user interface device, information confirming the user profile information;
storing, in response to the receiving the information confirming the user profile information, the user profile information in a tangible non-transient storage device; and
enabling the creating the advertising campaign information in response to the receiving the information confirming the user profile information.

5. The computer-implemented method of claim 1, further comprising:
receiving, via a user interface device, additional campaign information describing:
an advertising campaign name; and
an advertising campaign description;
associating the received additional campaign information with the advertising campaign information; and
storing, in a tangible non-transient storage device, the received additional campaign information with the advertising campaign information.

6. The computer-implemented method of claim 1, further comprising displaying, on a screen of the user device, information describing:
an advertising campaign name;
the advertising campaign start date;
the advertising campaign end date;
the budget for the advertising campaign;
an amount of funds spent to date on the advertising campaign;
a total number of advertisements in the advertising campaign;
a number of user inputs received to date as a result of the advertising campaign; and
a campaign calendar identifying the advertising campaign start date, the advertising campaign end date, and all dates therebetween.

7. The computer-implemented method of claim 1, further comprising displaying, on a screen of the user device, information describing:
a campaign calendar identifying the advertising campaign is unpaid for; and
a request for payment information.

8. A system for scheduling automated information delivery to a user device, the system comprising:
a physical processor; and
a memory communicably coupled to the physical processor and storing instructions configured to cause the physical processor to:
receive, automatically via an application programming interface executed by the at least one tangible processor, information describing:
demographics of potential hotel guests;
a geographic location of the potential hotel guests;
pricing for room rental in the hotel;
a uniform resource locator of a hotel website describing amenities of the hotel and at least one image of the hotel;
user input describing a characteristic of a target audience of the advertising campaign; and
user input describing a budget for the advertising campaign;
create, using a machine learning algorithm processing the received information, advertising campaign information, wherein the information describing the advertising campaign comprises:
instructions configured to direct an Internet search website to automatically display advertisements for the hotel that accompany search results displayed by the Internet search website, between an advertising campaign start date and an advertising campaign end date, and to the potential hotel guests in the geographic location of the potential hotel guests;
the information describing the amenities of the hotel and the at least one image of the hotel;
the information describing the pricing for room rental in the hotel; and
information describing a competitive advertising budget; and
send the instructions configured to direct the Internet search website to automatically display the advertisements for the hotel to a server device configured to automatically cause the advertisements for the hotel to be displayed on the user device.

9. The system of claim 8, wherein the memory further stores instructions configured to cause the physical processor to retrieve, using the uniform resource locator, the information describing the amenities of the hotel and the at least one image of the hotel.

10. The system of claim 8, wherein the memory further stores instructions configured to cause the physical processor to receive, from a user interface device, an instruction to initiate performing the creating the advertising campaign information step.

11. The system of claim 8, wherein the memory further stores instructions configured to cause the physical processor to:
receive, via a user interface device, user profile information describing:
a username;
a user email address;
a user company; and
the uniform resource locator of the hotel website;
receive, via the user interface device, information confirming the user profile information;
store, in response to the receiving the information confirming the user profile information, the user profile information in a tangible non-transient storage device; and
enable the creating the advertising campaign information in response to the receiving the information confirming the user profile information.

12. The system of claim 8, wherein the memory further stores instructions configured to cause the physical processor to:
receive, via a user interface device, additional campaign information describing:
an advertising campaign name; and
an advertising campaign description;
associate the received additional campaign information with the advertising campaign information; and
store, in a tangible non-transient storage device, the received additional campaign information with the advertising campaign information.

13. The system of claim 8, wherein the memory further stores instructions configured to cause the physical processor to display, on a screen of the user device, information describing:
an advertising campaign name;
the advertising campaign start date;
the advertising campaign end date;
the budget for the advertising campaign;
an amount of funds spent to date on the advertising campaign;
a total number of advertisements in the advertising campaign;
a number of user inputs received to date as a result of the advertising campaign; and
a campaign calendar identifying the advertising campaign start date, the advertising campaign end date, and all dates therebetween.

14. The system of claim 8, wherein the memory further stores instructions configured to cause the physical processor to display, on a screen of the user device, information describing:
a campaign calendar identifying the advertising campaign is unpaid for; and
a request for payment information.

15. A non-transitory computer-readable medium comprising one or more computer-executable instructions that, when executed by at least one processor of a computing device, cause the computing device to:
receive, automatically via an application programming interface executed by the at least one processor, information describing:
demographics of potential hotel guests;
a geographic location of the potential hotel guests;
pricing for room rental in the hotel;
a uniform resource locator of a hotel website describing amenities of the hotel and at least one image of the hotel;
user input describing a characteristic of a target audience of the advertising campaign; and
user input describing a budget for the advertising campaign;
create, using a machine learning algorithm processing the received information, advertising campaign information, wherein the information describing the advertising campaign comprises:
instructions configured to direct an Internet search website to automatically display advertisements for the hotel that accompany search results displayed by the Internet search website, between an advertising campaign start date and an advertising campaign end date, and to the potential hotel guests in the geographic location of the potential hotel guests;
the information describing the amenities of the hotel and the at least one image of the hotel;
the information describing the pricing for room rental in the hotel; and
information describing a competitive advertising budget; and
send the instructions configured to direct the Internet search website to automatically display the advertisements for the hotel to a server device configured to automatically cause the advertisements for the hotel to be displayed on a user device.

16. The non-transitory computer-readable medium of claim 15, wherein the computer-executable instructions are further configured to cause the computing device to retrieve, using the uniform resource locator, the information describing the amenities of the hotel and the at least one image of the hotel.

17. The non-transitory computer-readable medium of claim 15, wherein the computer-executable instructions are further configured to cause the computing device to receive, from a user interface device, an instruction to initiate performing the creating the advertising campaign information step.

18. The non-transitory computer-readable medium of claim 15, wherein the computer-executable instructions are further configured to cause the computing device to:
receive, via a user interface device, user profile information describing:
a username;
a user email address;
a user company; and
the uniform resource locator of the hotel website;
receive, via the user interface device, information confirming the user profile information;
store, in response to the receiving the information confirming the user profile information, the user profile information in a tangible non-transient storage device; and
enable the creating the advertising campaign information in response to the receiving the information confirming the user profile information.

19. The non-transitory computer-readable medium of claim 15, wherein the computer-executable instructions are further configured to cause the computing device to:
receive, via a user interface device, additional campaign information describing:
an advertising campaign name; and
an advertising campaign description;
associate the received additional campaign information with the advertising campaign information; and
store, in a tangible non-transient storage device, the received additional campaign information with the advertising campaign information.

20. The non-transitory computer-readable medium of claim 15, wherein the computer-executable instructions are further configured to cause the computing device to display, on a screen of the user device, information describing:
an advertising campaign name;
the advertising campaign start date;
the advertising campaign end date;
the budget for the advertising campaign;
an amount of funds spent to date on the advertising campaign;
a total number of advertisements in the advertising campaign;
a number of user inputs received to date as a result of the advertising campaign; and
a campaign calendar identifying the advertising campaign start date, the advertising campaign end date, and all dates therebetween.

21. The non-transitory computer-readable medium of claim 15, wherein the computer-executable instructions are further configured to cause the computing device to display, on a screen of the user device, information describing:
a campaign calendar identifying the advertising campaign is unpaid for; and
a request for payment information.
